(19) United States
(12) Patent Application Publication
(10) Pub. No.: US 2014/0347329 A1
(43) Pub. Date: Nov. 27, 2014

(54) Pre-Button Event Stylus Position

(71) Applicant: zSpace, Inc., Sunnyvale, CA (US)

(72) Inventor: John C. Ware, Millbrae, CA (US)

(73) Assignee: z Space,Inc. a corporation

(21) Appl. No.: 14/358,755

(22) PCT Filed: Nov. 16, 2012
(86) PCT No.: PCT/US2012/065621

§ 371 Date: May 16, 2014

Related U.S. Application Data
(60) Provisional application No. 61/561,733, filed on Nov. 18, 2011.

(51) Int. Cl. G06F 3/0354

(52) U.S. Cl. CPC G06F 3/03545
USPC 345/179

(57) ABSTRACT

Embodiments of the present invention generally relate to methods and systems for correcting position and orientation displacement for a freehand user input device. Systems and methods include measuring the position and orientation of a freehand user input device over a period of time, determining the position and orientation as related to a specific time point at activation of a button, applying a temporal offset to the time point of the activation of the button to determine a button press start time, determining the position and orientation in the virtual space associated with the button press start time and associating the button press to the position and orientation in the virtual space.

### CROSS-REFERENCE TO RELATED APPLICATIONS

This application claims benefit of U.S. provisional patent application Ser. No. 61/561,733, filed Nov. 18, 2011, which is herein incorporated by reference.

### BACKGROUND OF THE INVENTION

1. Field of the Invention

Embodiments of the present invention generally relate to an apparatus and a method for control of stylus positioning. Particularly, embodiments of the present invention relate generally to apparatus and methods for maintaining stylus positioning as reflected on a display during pressure-sensitive or touch-sensitive interface activation.

2. Description of the Related Art

Most computer-assisted drawing (CAD) utilizes an interactive three dimensional (3D) interface to produce lifelike representations of the intended object. Interactive 3D systems allow the user to create (render), view and interact with one or more virtual 3D objects in a virtual 3D scene space. The 3D objects are generally rendered at least with consideration to position on an X-axis, Y-axis and Z-axis as well as rotation on each axis, also known as yaw, pitch and roll within the virtual scene. When altering or manipulating these 3D objects, it is important to be able to control both the position in space as well as the rotation of the object at the specified position.

Various means are known for interaction with a 3D object, such as controllers, keyboard and mouse combinations, or electronic pen-like devices, such as a stylus. Keyboards provide a high level of precision but also a slow interface. Controllers and keyboards are limited in that the parameters of the 3D object are controlled by numerous buttons. Further, their indirect nature inhibits quick experimentation, and requires either numerically entering six numbers (providing position on the coordinate plane and rotation on each axis) or using mouse-keyboard chorded events to interactively change values. Though numerous buttons might increase precision, it creates a slow, bulky and ultimately non-intuitive means for rendering and controlling a 3D object.

A stylus can be used to control an object in with six degrees of freedom by physically moving the stylus in a real space corresponding to the virtual 3D space. The stylus interacts in this virtual 3D space without resting or even necessarily contacting another object. Other non-motion related interaction by the stylus, such as selection of the 3D object or points in space, are generally controlled by one or more buttons positioned on the stylus. The buttons allow for secondary interactions with the 3D space but simultaneously create motion distortions. An inherent limitation of being able to freely move an object in a virtual 3D space based on real world movement of the stylus is that even minor distortions in that movement, such as those from pressure-sensitive or touch-sensitive interfaces (such as a button) on the stylus, may be reflected in the rendered 3D object or the position thereof. Therefore, the ease of use of a stylus (or any device where there is some activation involved, especially if that activation occurs in a free physical space volume) is counterbalanced by motion distortions related to pressure-sensitive or touch-sensitive interfaces on the stylus.

As such, there is a need in the art to better control the position of a stylus during interaction with a display

### SUMMARY OF THE INVENTION

Embodiments of the present invention generally relate to an apparatus and a method for control of stylus positioning. In one embodiment, a system can include a display screen configured to project a virtual space to a user comprising one or more projections; a freehand user input device having a button; a tracking device configured to position a pointer in a first position and a first orientation in the virtual space correlated to a first position and first orientation of the freehand user input device in the physical space, detect that a button has been activated on the freehand user input device to affect the one or more projections in the virtual space, detect that the freehand user input device has moved to a second position and second orientation in the physical space and the pointer has moved to a second position and second orientation in the virtual space and correlate the activation of the button to a third position and third orientation in the virtual space in response to the detecting.

In another embodiment, a system can include a display screen configured to render a projected virtual space to a user comprising one or more projections; a freehand user input device having a button; a tracking device configured to position a virtual pointer in a first position and a first orientation in the virtual space correlated to a first position and first orientation of the freehand user input device in the physical space, where the first position and the first orientation in the virtual space intersects a virtual object at the first position and first orientation in the virtual space, detect that the button has been activated on the freehand user input device to affect the virtual object at the first position and the first orientation in the virtual space, detect that the freehand user input device has moved to a second position and second orientation in the physical space and the virtual pointer has moved to a second position and second orientation in the virtual space, correlate the activation of the button to the first position and first orientation in the virtual space in response to the detecting, upon detecting that the button has been activated on the freehand user input device, perform the button activation effect on the virtual object and render the object in rendering the projected virtual space on the display screen.

In another embodiment, a system can include a display screen configured to render a projection of a virtual space to a user comprising one or more projections; a freehand user input device having a button; and a tracking device configured to position a virtual pointer in a first position and a first orientation in the virtual space with a one to one correspondence to a first position and first orientation of the freehand user input device in the physical space, detect that a button has been pressed on the freehand user input device to affect the one or more projections in the virtual space, detect that the freehand user input device has moved to a second position and second orientation in the physical space and the virtual pointer has moved to a second position and second orientation in the virtual space, move the pointer in the virtual space to a third position and third orientation in the virtual space in response to the detecting, independent of the second position and second orientation of the freehand user input device in the physical space and upon performing the effect, return the position and orientation of the virtual pointer in the virtual space to a one to one correspondence with the position and orientation of the freehand user input device in the physical space.

In another embodiment, a method can include positioning and/or orienting a freehand user input device in a first position and first orientation in a physical space, wherein the positioning and/or orienting causes a corresponding virtual pointer in a virtual space to be positioned and/or oriented in a first position and a first orientation in the virtual space; detecting that a button has been activated on the freehand user input device to affect a virtual object in the virtual space associated with the corresponding virtual pointer's first position and first orientation, wherein the freehand user input device has moved to a second position and second orientation in the physical space and the corresponding virtual pointer has moved to a second position and second orientation in the virtual space and correlating the activation of the button to a third position and third orientation in the virtual space in response to the detecting.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an exemplary display screen shown interacting with an exemplary freehand user input device according to one embodiment;

FIG. 2 depicts positioning displacement of a freehand user input device and the corresponding pointer both in the physical space and the virtual scene based on a button activation according to one embodiment;

FIGS. 3A-3C depict correction for positioning displacement according to one embodiment;

FIGS. 4A-4C depict correction for positioning displacement according to another embodiment; and

FIG. 5 is a block diagram of a method for correction of position displacement according to one or more embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

### Terms

The following is a list of terms used in the present application:

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Viewpoint—This term has the full extent of its ordinary meaning in the field of computer graphics/cameras and specifies a location and/or orientation. For example, the term “viewpoint” may refer to a single point of view (e.g., for a single eye) or a pair of points of view (e.g., for a pair of eyes). Thus, viewpoint may refer to the view from a single eye, or may refer to the two points of view from a pair of eyes. A “single viewpoint” may specify that the viewpoint refers to only a single point of view and a “paired viewpoint” or “stereoscopic viewpoint” may specify that the viewpoint refers to two points of view (and not one). Where the viewpoint is that of a user, this viewpoint may be referred to as an eyepoint (see below) or “physical viewpoint”. The term “virtual viewpoint” refers to a viewpoint from within a virtual representation or 3D scene.

Eye point—the physical location (and/or orientation) of a single eye or a pair of eyes. A viewpoint above may correspond to the eyepoint of a person. For example, a person's eyepoint has a corresponding viewpoint.

Vertical Perspective—a perspective that is rendered for a viewpoint that is substantially perpendicular to the display surface. “Substantially perpendicular” may refer to 90 degrees or variations thereof, such as 89 and 91 degrees, 85-95 degrees, or any variation which does not cause noticeable distortion of the rendered scene. A vertical perspective may be a central perspective, e.g., having a single (and central) vanishing point. As used herein, a vertical perspective may apply to a single image or a stereoscopic image. When used with respect to a stereoscopic image (e.g., presenting a stereoscopic image according to a vertical perspective), each image of the stereoscopic image may be presented according to the vertical perspective, but with differing single viewpoints.

Horizontal or Oblique Perspective—a perspective that is rendered from a viewpoint which is not perpendicular to the display surface. More particularly, the term “horizontal perspective” may typically refer to a perspective which is rendered using a substantially 45 degree angled render plane in reference to the corresponding viewpoint. The rendering may be intended for a display that may be positioned horizontally (e.g., parallel to a table surface or floor) in reference to a standing viewpoint. “Substantially 45 degrees” may refer to 45 degrees or variations thereof, such as 44 and 46 degrees, 40-50 degrees, or any variation that may cause minimal distortion of the rendered scene. As used herein, a horizontal perspective may apply to a single image or a stereoscopic image. When used with respect to a stereoscopic image (e.g., presenting a stereoscopic image according to a horizontal perspective), each image of the stereoscopic image may be presented according to the horizontal perspective, but with differing single viewpoints.

Position—the location or coordinates of an object (either virtual or real). For example, position may include X-axis, Y-axis and Z-axis coordinates within a defined space. The position may be relative or absolute, as desired.

Orientation—Orientation is the configuration of a user or object at a single position in space. Stated another way, orientation defines the rotational movement of a user or object as measured by the display. Orientation may include yaw, pitch, and roll information, e.g., when defining the orientation of a viewpoint.

Degrees of Freedom—The degrees of freedom generally refer to an input device. Each degree of freedom expresses an additional parameter provided by the input device. It typically requires at least one degree of freedom to indicate or change position and at least one degree of freedom to indicate or change orientation. The six degrees of freedom are composed of three position components, and three rotational components.

Freehand User Input Device—any device that allows a user to interact with a display using the six degrees of freedom generally in a free space volume described above.

Interpreted direction—an interpreted direction is the expected direction of movement of an object or a user when the object or user has a designated front and the position and orientation of the object or user are known. The object or user point in the direction that the designated front is configured, based on the user's or object's position and orientation. For example, a stylus with a physical endpoint is points in the direction that the physical end point is oriented towards from the stylus' current position.

Stereo Display Configured with a Freehand user Input Device

Embodiments of the present invention generally relate to an apparatus and a method for control of stylus positioning and orientation. Particularly, embodiments of the present invention relate generally to apparatus and methods for correcting stylus position and orientation as reflected on a stereo display during button activation. For accurate interaction in real time with a virtual space, a user can optimally use a freehand user input device, such as a stylus. The freehand user input device can have a corresponding point in the virtual space, such as a cursor, which corresponds to the position of the freehand user input device.

The freehand user input device will generally have some means of communicating with the virtual objects in the virtual space, the virtual objects are then projected for imaging. A means of communication with the virtual objects in the virtual space can include a stylus with a button. In this embodiment, the user will generally depress the button within the physical space so as to interact with the virtual object that is targeted by the cursor as projected in the virtual space, where there is a correlation between the generated Stereo Image viewed to a perceived position of an object as found in a correlated spatial location within the virtual space. When the user depresses the button, and thereby applies a certain amount of force to the button, the freehand user input device inevitably shifts in the physical space. This shift can be in position (movement on the X, Y, or Z-axis), in orientation (rotation on the X, Y, or Z-axis). Since the shift is not intended by the user, the user must attempt to reposition themselves and accommodate for the level of force that they apply to the freehand user input device.

By measuring the position and orientation of the freehand user input device from a reference and associating the interaction to a position that reflects the intended position, the manual dexterity required of the end user will be minimized and accuracy of selections and interactions will be improved. The invention disclosed herein is more fully explained with reference to the figures below.

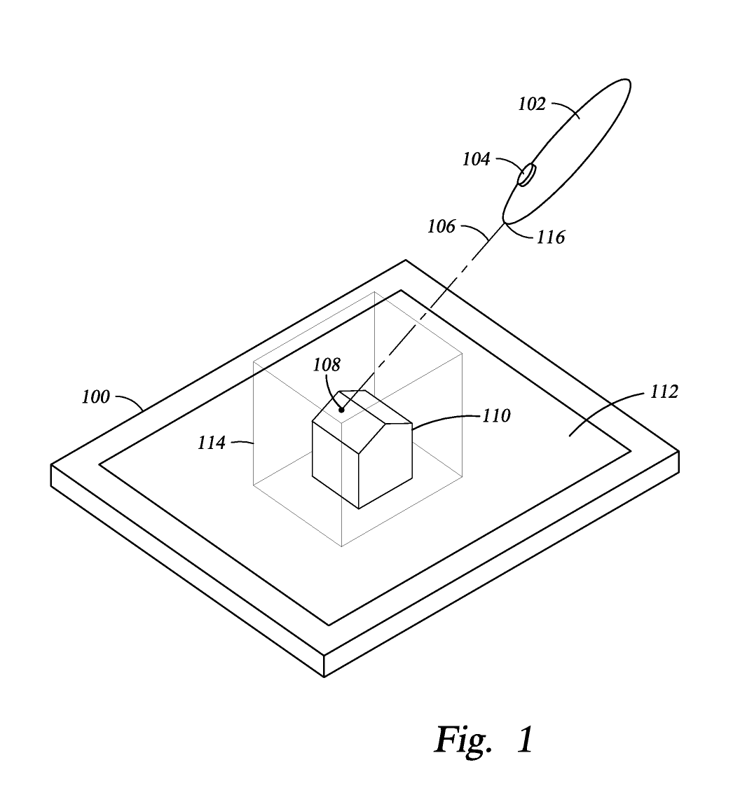

FIG. 1 is an exemplary display screen shown interacting with an exemplary freehand user input device, according to one embodiment. In this embodiment, a freehand user input device, such as a stylus 102, may be positioned in the physical space. Though depicted herein as a stylus, it is envisioned that any type of freehand user input device might be employed without diverging from the scope of the invention disclosed herein. A freehand user input device is any device which allows a user to virtually interact with display screen imaged objects using the six degrees of freedom described above. More specifically, a freehand user device is any device that can be tracked in the physical space by the display to allow the user to interact with the virtual scene from the viewpoint of the freehand user input device. Examples of freehand user input devices, when configured to perform the method described herein, can include a stylus, a glove, a finger attachment, the user's hand/finger or other object which can be tracked for position, orientation and directionality.

The stylus 102 has a button 104, which may be one of several buttons, disposed thereon. The button 104 can be an analog button, such as a button which requires physical depression to activate, where the point of registered activation is a function of the throw of the physical button employed. In further embodiments, the button 104 can be a touch responsive button, wherein the button would not require physical depression to activate. The stylus can have a physical endpoint 116. The physical endpoint 116 can be proximate the button 104. Further, the physical endpoint 116 may be a pointing end of the stylus 102, thus creating directionality for the stylus 102.

The stylus 102 as positioned in the physical space can be detected by sensors associated with a display 100 or by some tracking mechanisms within the stylus. The display 100 may comprise one or more detection devices (not shown). The detection devices may be cameras or other forms of wireless detection. The detection devices can detect the position and orientation of the stylus 102 in the physical space as compared to the position and orientation of the display 100. The display 100 has a screen 112. The screen 112 can be configured to display one or more visual objects 110.

The object 110 can be viewed as an image or a stereo image pair that is one image displayed at a first polarization for the right eye and one image displayed at a second polarization for the left eye. The object 110, when viewed by a user wearing a stereo decoding device, such as polarizing glasses (not shown), can see the object 110 as a 3D object perceived to be positioned within a view volume. The object 110, when displayed so as to create the appearance of a physically present 3D object can appear to the user to be projected within a physical space 114 from the projection within the virtual space. In this depiction the object 110 appears to be a house. However, the type of object depicted here as the object 110 is not to be considered limiting of the invention described herein. The object 110 could be a single image, multiple images, an entire virtual scene or other combinations as desired by the user.

The pointer 106 can be projected in the virtual space. The pointer 106 can appear to be extending from the physical endpoint 116 of the stylus 102. The positioning and orientation of the pointer 106 can correspond to a line segment extending out from the position of the physical endpoint 116 with the orientation of the stylus 102 and in the interpreted direction of the stylus 102. The pointer 106 appears to be extending out from the physical endpoint 116 to a point of intersection 108 with the object 110. The point of intersection 108 may correspond with the position and orientation of the physical endpoint 116. Further, the point of intersection 108 may correspond with a virtual beam imaged as a continuous line extending from the physical endpoint, such as depicted for pointer 106, extending from the physical endpoint 116 of the stylus 102, in the interpreted direction by the stylus 102 wherein the movement of the pointer 106 is blocked by object 110. In this embodiment, the object 110 is perceived as being a solid (or with some transparency) object, thus the passage of the pointer 106 is blocked by the object 110 thus ascribing a point of intersection 108 to the virtual solid surface of the object 110. Further, the point of intersection 108 may refer to a virtual end point in the virtual space 114, such that the pointer 106 ends in the virtual space 114 without an apparent collision.

Though the pointer 106 is depicted as a virtual beam extending from the physical endpoint 116 of the stylus 102, neither the virtual beam nor any other image projected in the virtual space along the line segment are required for the invention described herein. In further embodiments, the pointer 106 may simply be represented by a cursor at a position and orientation in the virtual space. In one or more embodiments, the pointer 106, when depicted as a virtual beam, can apparently extend and contract, as rendered in the virtual space 214. The extension and contraction of the pointer 106 can be controlled manually by the user or through instructions written for a computer and imaged by the display 100. Further embodiments may also include no image being rendered to correspond with the line. One skilled in the art will understand that there are a limitless number of permutations for the pointer 106 described herein.

The button 104 is depressed by the user with the intent to interact with the object 110, either at the specific point of intersection 108 or with the object generally. Interaction with the object 110 can include selecting the object 110 or a portion of the object 110, such as selecting the roof of a house. Interaction can further include deleting the object 110 or moving the object 110. Though a few embodiments of possible interactions are disclosed, it is envisioned that all possible interactions with the object 110 are contemplated.

In further embodiments, 2D objects (not shown), such as a drop-down menu can be displayed on the screen 112 alongside 3D objects, such as object 110. The 2D object can be depicted as positioned within, above or below the virtual space. The stylus 102 can be then be repositioned with the physical space so that the corresponding pointer 106 is depicted in the virtual space as interacting with the 2D object. In this embodiment, the 2D object can be treated as a solid plane. Thus, the passage of the pointer 106 is blocked by the 2D object thus ascribing a point of intersection 108 with the virtual surface of the 2D object. In further embodiments, position of the pointer 106 on one of either the X, Y or Z-axis and the corresponding orientation on that axis, as presented in the virtual space 110, can be ignored by the display 100. In this embodiment, the pointer 106, as controlled by the user through the stylus 102 would move in two dimensions when positioned in proximity to or over the 2D object.

In further embodiments, the length of the pointer 106 and corresponding point of intersection 108 can be modified, wherein the length of the pointer 106 is extended in relation to the physical endpoint 116 and the point of intersection 108 (utilizing stylus tracking as specified in “Three-Dimensional Tracking of Objects in a 3-D Scene” Ser. No. 61/426,448 filed Dec. 22, 2010, incorporated herein by reference). In one embodiment, the stylus 102 has one or more buttons, the activation of at least one of these buttons correlating with a extension and contraction of the virtual pointer 106 as displayed in the virtual space 114. In another embodiment, the user may use a keyboard key to employ the pointer lengthening/shortening process.

In further embodiments, to extend the length of the stylus virtual pointer 106 and extend the position of the virtual stylus tip at the end of the beam, the user has the stylus with the beam rendered at a first length at first position in the corresponding virtual space. By selecting a defined key or performing another command action, the user locks the position and orientation of the point of intersection for the pointer in the virtual space. At this point, the user pulls the stylus back or pushes the stylus in but the point of intersection remains in place. This results in the pointer being extended between the stylus and the point of intersection. When the user releases the defined key, the extension ends.

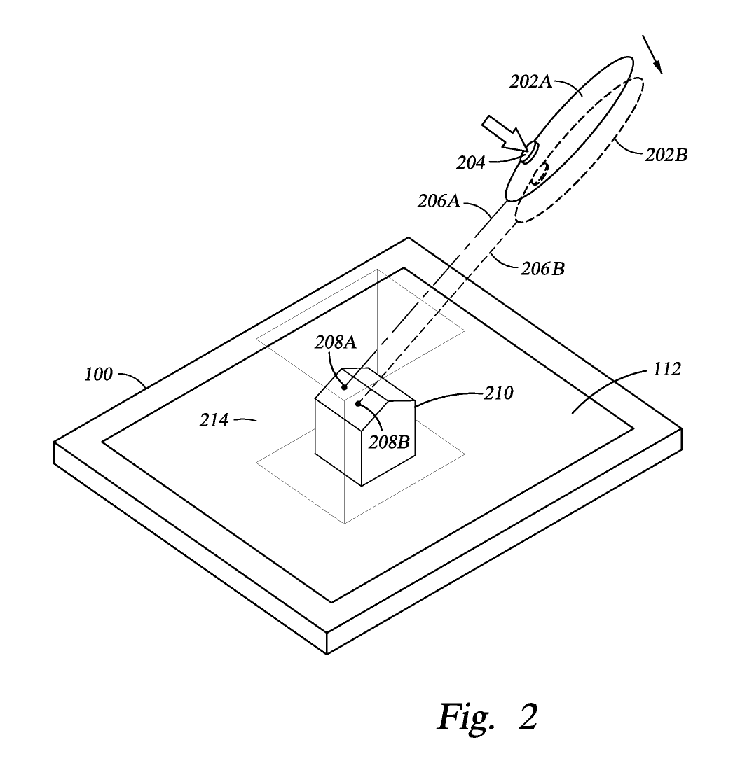

FIG. 2 depicts positioning displacement of a freehand user input device and the corresponding pointer both in the physical space and the virtual scene based on a button activation according to one embodiment. In this embodiment, the display 100 renders an image 210 that is projected in a virtual space 210 as displayed on the screen 112. The freehand user input device, depicted here as a stylus 202A, is positioned in the physical space at a first position before the user depresses the button 204. In this embodiment, the user has positioned and oriented the stylus 204 in the physical space, which the sensors associated with display 100 detects. The display 100 processor uses the detected information to form an image to render the pointer 206A with a point of intersection 208A from the virtual space with the position, orientation and directionality as described previously.

As the user depresses the button 204 on the stylus 202A, the stylus 202A shifts to the position of 202B. This effect is related to the force applied to the button and the inevitability that the user will not be able to control all directional forces when applying a force to a stylus with six degrees of freedom in free space with no corresponding counter force to act against the movement of the button being depressed. The display 100 electronics determines the new position of the stylus 202B and associates the pointer 206A corresponding a location or locations in the virtual space and the point of intersection 208A with the stylus 202B by shifting them to the position of pointer 206B and point of intersection 208B. As shown here, the associated activation of the button 204 occurs at point of intersection 208B when the user intended the activation of button 204B to be at point of intersection 208A.

The shift shown between stylus 202A and stylus 202B is depicted as in the direction that the force is applied and showing only a change in position as opposed to orientation for sake of simplicity. It is contemplated that the force applied to the button 204 can cause a change both in the position and the orientation of the device. Further, this change in position and orientation can be in the direction or tangential to the direction of the applied force. However, it is understood that the change in position and orientation does not necessarily correlate with the direction of the force applied, as the user will likely attempt to compensate for the force of the button press on the stylus 202B.

Correction of Freehand user Input Device-Positioning Displacement

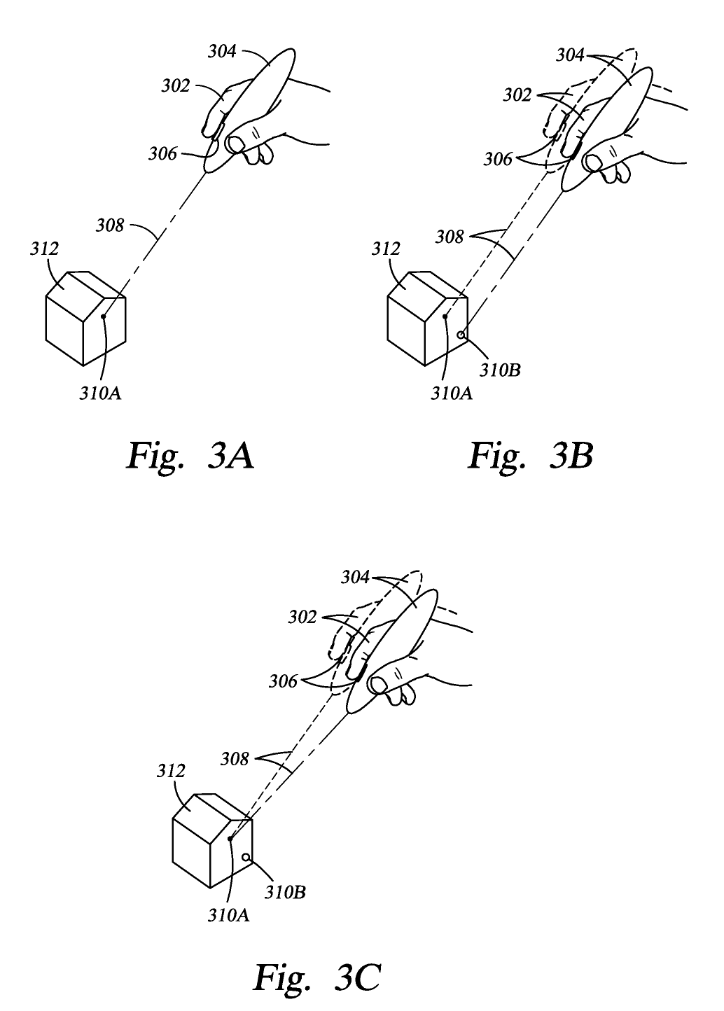

FIGS. 3A-3C depict correction for stylus positioning displacement, according to one embodiment. In the simplified depiction in FIG. 3A, the user 302 has positioned a stylus 304 in the physical space (not shown). The stylus 304 has a button 306. The stylus 304 has been positioned and oriented to position the virtual pointer 308 in the virtual space at a point of intersection 310A on object 312. The display 100 electronics, described with reference to FIGS. 1 and 2, monitors the position and orientation of the stylus 304 and positions/orients the pointer 308 accordingly.

FIG. 3B depicts the user 302 attempting to interact with object 312. In FIG. 3B, the user 302 with the stylus at the then current position/orientation depresses the button 306 and thus applies a force to both the button 306 and the stylus 304. The stylus 304 shifts from the first position/orientation to the second position/orientation, as depicted by the dotted line drawing as the first position/orientation and the solid line drawing as the second position/orientation. The shift in the position and orientation of the stylus 304 causes the pointer 308 the shift to a correlated position and orientation in the virtual space (not shown) shifting the point of intersection 310A to a point of intersection 310B.

FIG. 3C depicts the correction of the point of intersection to the intended point. In FIG. 3C, position of the point of intersection 310B is shifted as compared to the intended point of intersection 310A. The display 100 electronics registers this and applies a temporal offset to the indicators (the pointer and the point of intersection) in the virtual space. Thus, the display 100 shifts the pointer 306 to the point of intersection 310A. This creates a pointer 306 that, at least momentarily, is no longer in the anticipated direction from the stylus 304.

The temporal offset is defined as a period of time between the beginning of the button press and the activation of the button. The temporal offset may be a measured time period for the button press, such as measured by a button which uses one or more of a camera, gyroscope, accelerometer apparatus to determine the precise beginning of the button press. The temporal offset may also be an expected amount of time, such as an offset determined by a series of measurements of the time involved in a button depression. Further examples, can include using an expected amount of time for the time frame form the button depression to the activation of the button. The above are simply exemplary embodiments of the temporal offset and are not intended to be limiting of the scope of possible corresponding periods of time that could be used as the temporal offset.

Applying the temporal offset generally means that one or more of the position and orientation of the effect of the activation is changed based on a period of time to reposition the effect of the activation in the position that the activation was intended. During the entire time of operation or some time frame therein, the display 100 can collect information on the actions of the user with regard to at least the stylus 304. The display 100 electronics can measure movement of the stylus 304 over a period of time. Thus the display 100 electronics would collect from the stylus 304 the positions and orientations of the stylus 304 on either the X-axis, Y-axis or Z-axis or an orientation over an extended period of time. The information regarding position and orientation of the stylus can be determined by the display 100 electronics based on the positioning of the stylus 304. Further, the stylus 304 can provide the display 100 electronics with telemetry data. The telemetry data from the stylus 304 can include the position and orientation of the stylus 304 with reference to the position of the display 100.

Determination of the temporal offset can be accomplished in a number of ways. The temporal offset can be an anticipated amount of time, such as a standard time from the beginning of a button press to the point that the button 306 has activated. Based on the design of the button 306, activation of the button 306 may not directly correlate with complete depression of the button 306. Further embodiments include a button 306 that allows for measurement of the movement of the button during the button press, such as a button with a roller or one or more cameras to detect movement. Further embodiments include creating a temporal offset based on an average from the time required by a user 302 to depress the button 306. By detecting subtle movements from the user that indicate that a button press has begun, the stylus 304 or the display 100 can calibrate to the user 302.

As well, application of the temporal offset to the pointer 306 can be accomplished in a number of ways. In one embodiment, the virtual pointer 306 is shifted back to the original point of intersection 310A thus momentarily offsetting the direction of the pointer 306 and the point of intersection 310. In another embodiment, the displacement of the pointer 306 in the virtual space is directly associated with the temporal offset and filtered out of the positioning of the pointer 306 as noise. In another embodiment, the object 312 is projected in the virtual space so as to accommodate for the displacement of the stylus 304. In further embodiments, less than all degrees of freedom are accommodated for by the display 100 electronics Stated differently, the display electronics can select which of the X-axis, Y-axis, or Z-axis or rotation thereon that should be adjusted based on the temporal offset.

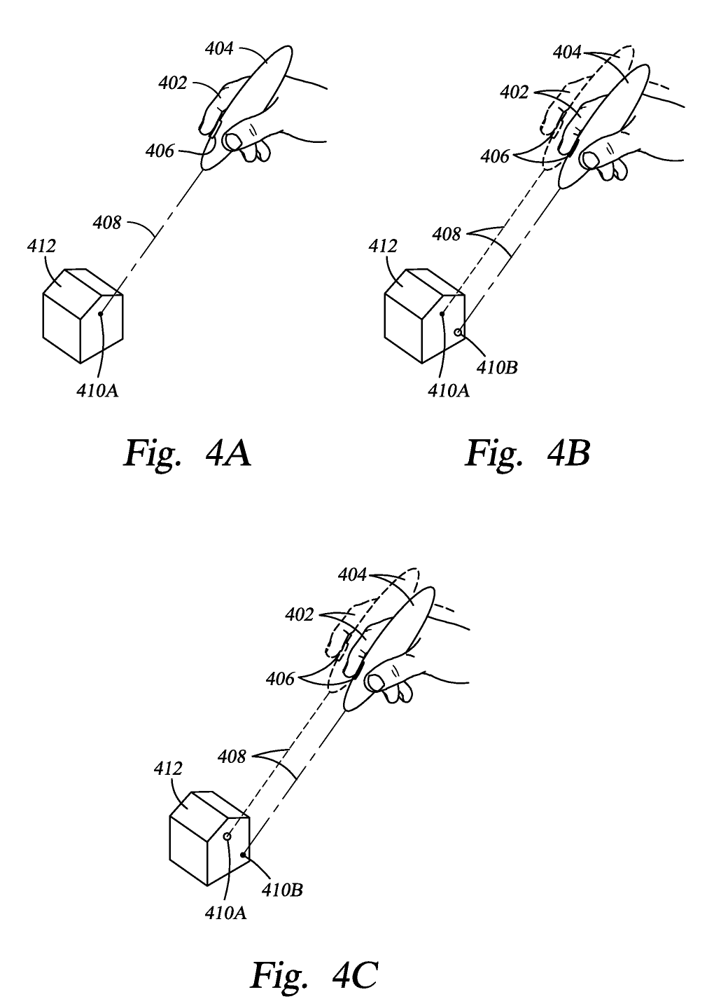

FIGS. 4A-4C depict correction for stylus positioning displacement, according to another embodiment. In FIG. 4A, the user 402 has positioned a stylus 404 in the physical space (not shown). The stylus 404 has a button 406 which is not depressed or activated. The stylus 404 is positioned and oriented to position the virtual pointer 408 in the virtual space at a point of intersection 410A on object 412. The display 100 electronics, described with reference to FIGS. 1 and 2, monitors the position and orientation of the stylus 404 and positions/orients the pointer 408 in the virtual space.

FIG. 4B depicts the user 402 activating the attempting to interact with object 412. As described above, the user 402 depresses the button 406 causing a shift in both the button 406 and the physical stylus 404. The physical stylus 404 shifts from the first position/orientation to the second position/orientation, as depicted by the dotted line drawing as the first position/orientation and the solid line drawing as the second position/orientation. The display 100 tracks the shift in the position and orientation of the stylus 404 and thus renders the pointer 408 at the correlated position and orientation in the virtual space (not shown). As well, the pointer 408 shifts the correlated point of intersection 410A to a point of intersection 410B.

FIG. 4C depicts the correction of the point of intersection to the intended point. In FIG. 4C, the pointer 408 remains at the position of the point of intersection 410B. The activation of the button 406 is detected by the display 100. The display 100 applies a temporal offset to the activation of the button 406 in the virtual space. To state it differently, the display 100 electronics applies the temporal offset to the time point of the activation of the button to determine the time point which corresponds to the point of intersection that the user likely desired. The display 100 electronics then associates the activation of the button 404 to the point of intersection 410A based on the temporal offset. Thus, in this embodiment, the display 100 electronics does not shift the pointer 406 to the point of intersection 410A. The above explanations with regards to determining the temporal offset apply to the embodiment described in FIG. 4A-4C.

It is important to note that the embodiments above, described with reference to a 3D object are also applicable to 2D objects. The application of the temporal offset based on tracked positions allows the movement of the freehand user input device to be applicable regardless the type of display or the dimensionality of objected displayed.

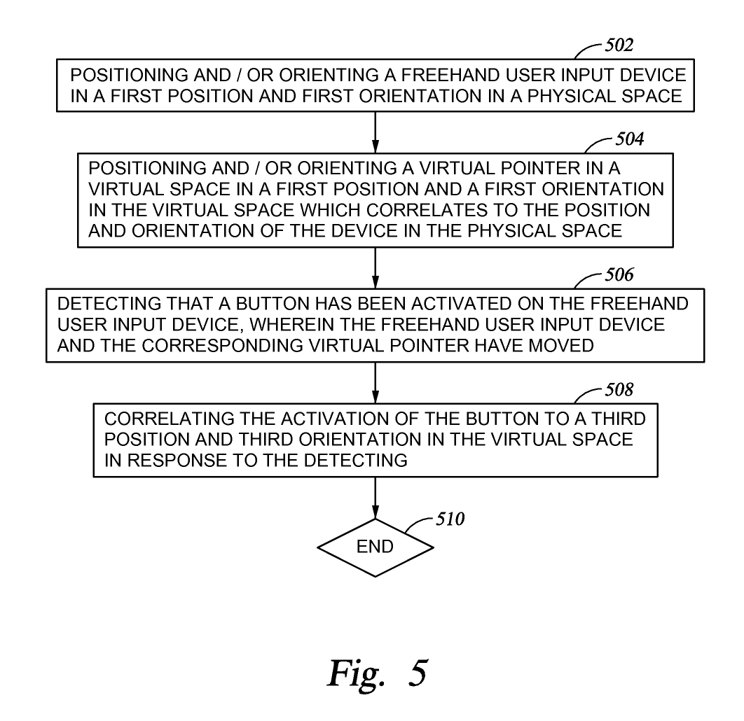

FIG. 5 is a block diagram of a method for correction of position displacement according to one or more embodiments. The method can include positioning and/or orienting a freehand user input device in a first position and orientation in a physical space, as in 502. As described previously, the freehand user input device can be any device that can be tracked by a display with six degrees of freedom. In the embodiments described above, a stylus is described as the preferred embodiment of the freehand user device. The freehand user input device is positioned in a physical space. The physical space that is used by the display is in proximity to the detection devices that are positioned on the display. In further embodiments, the detection devices can be positioned away from the display. The detection devices can determine and track the position and orientation of the freehand user input device in the physical space.

The method can further include positioning and/or orienting a virtual pointer in a virtual space in a first position and a first orientation in the virtual space, which correlates to the position and orientation of the freehand user input device in the physical space, as in 504. The virtual pointer can be projected in the virtual space based on the position and/or orientation of the freehand user input device in the physical space. The correlation between the virtual pointer and the freehand user input device may be a 1:1 correlation.

The freehand user input device may be used to interact with the presented 3D virtual scene, such as by manipulating objects in a screen space of the 3D virtual scene. For example, freehand user input device may be used to directly interact with virtual objects of the 3D virtual scene (via the viewed projected objects). However, this direct interaction may only be possible with “open space” portions of the 3D virtual scene. Thus, at least a portion of the 3D virtual scene may be presented (or imaged) in the open space, which is in front of or otherwise outside of the at least one screen. In some embodiments, the open space portion of the 3D virtual scene may appear as a hologram above the surface of the screen. Thus, open space refers to a space which the user is able to freely move and interact with (e.g., physical space upon which the illusion is apparently projected) rather than a space the user cannot freely move and interact with (e.g., where the user is not able to place his hands in the space, such as below the screen surface). The user can interact with virtual objects in the open space because they are proximate to the user's own physical space. An inner volume is located behind the viewing surface and presented objects appear inside the physically viewing device. Thus, virtual objects of the 3D virtual scene presented within the inner volume do not share the same physical space with the user and the objects therefore cannot be directly, physically manipulated by hands or hand-held tools such as the freehand user input device. That is, they may be manipulated indirectly, e.g., via a virtual beam from a freehand user input device correlated in to the inner volume portion of the virtual scene.

In some embodiments, this virtual space interaction may be achieved by having a 1:1 correspondence between the virtual objects (e.g., in the inner volume) and projected objects (e.g., in the physical space). Thus, an accurate and tangible physical interaction is provided by allowing a user to touch and manipulate projected objects with his hands or hand held tools, such as freehand user input device. This 1:1 correspondence of the virtual elements and their physical real-world equivalents is described in more detail in U.S. Patent Publication No. 2005/0264858, which was incorporated by reference in its entirety above. This 1:1 correspondence may allow the user to physically and directly access and interact with projected objects of the 3D virtual scene. This 1:1 correspondence may utilize the creation of a common physical reference plane, where there is a determined correlation between the display surface and the tracking sensors that detect and track the user and hand held tools (in some embodiments the tracking sensors are affixed to the display device in a system known offset position and orientation), as well as, the formula for deriving its unique x-axis, y-axis, and z-axis spatial coordinates, thereby correlating the physical coordinate environment to the virtual coordinate environment. Additionally, the 1:1 correspondence allows the user's movement of virtual objects or other interaction to be the same in physical space and in presented space. However, other embodiments are envisioned where there is a ratio between the distance of the user's physical movement and the corresponding movement in the presented 3D virtual scene.

The method can further include detecting that a button has been activated on the freehand user input device, wherein the freehand user input device and the corresponding virtual pointer have moved, as in 506. The freehand user input device is defined to be at a first position and first orientation in relation to the display. When the button on the freehand user input device is activated, the freehand user input device will shift to a second position and a second orientation. The freehand user input device will move to some extent for each user, depending on that user's level of control over the device during the button depression. Once the button is activated, the display then can define the points related to the beginning of the button press and the actual activation of the button.

The method can include correlating the activation of the button to a third position and third orientation in the virtual space in response to the detecting, as in 508. The position and orientation of the pointer or the freehand user device is recorded over a period of time. As such, this period of time will necessarily include the position and orientation when the button press began and the position and orientation when the activation completed.

Using the predetermined activation time point and the temporal offset, the display can then determine which recorded point corresponds to the third position and third orientation. The third position and third orientation are a position and orientation which are either exactly or approximately the position and orientation when the button press began. If the display is using a general time frame for the temporal offset, then the third position will always be a specific point prior to the activation. Since the actual button press may have been faster or slower than the time frame for the offset, the third position will not always be the first position. In other embodiments, such as when measuring the actual button press or by calculating the offset based on prior button presses, the temporal offset used by the display can better approximate the first position and first orientation.

In further embodiments, the positions and orientations described above may correspond to a general region around a point and not a specific point. In one embodiment, if the user attempted to click a button in the virtual space and was slightly misaligned in position or orientation from the button based on the position of the freehand user input device in the physical space at the beginning of the button press, the display can detect that the user intended to click the button in the virtual space and associate the activation as described above.

### CONCLUSION

Embodiments described herein relate to systems and methods of correcting the position and orientation of a pointer as rendered in a virtual space with reference to a freehand user input device. By activating a button on a freehand user input device, the device can be displaced in position and/or orientation from the intended target of the user. By collecting information regarding the position and orientation of the freehand user input device in the physical space and the pointer in the virtual space over time, determining the time point of activation for the button, and using a temporal offset to associate the activation of the button with a previous position and orientation of the pointer in the virtual space, the movement can be accommodated for and the proper target can be selected in the virtual space.

While the foregoing is directed to embodiments of the present invention, other and further embodiments of the invention may be devised without departing from the basic scope thereof, and the scope thereof is determined by the claims that follow.

What is claimed is:

1. A system, comprising:
a display screen configured to project a virtual space to a user comprising one or more projections;
a freehand user input device having a button;
a tracking device configured to:
position a pointer in a first position and a first orientation in the virtual space correlated to a first position and first orientation of the freehand user input device in the physical space;
detect that a button has been activated on the freehand user input device to affect the one or more projections in the virtual space;
detect that the freehand user input device has moved to a second position and second orientation in the physical space and the pointer has moved to a second position and second orientation in the virtual space; and
correlate the activation of the button to a third position and third orientation in the virtual space in response to the detecting either that the button has been activated, or that the freehand user input device or the pointer has moved.

2. The system of claim 1, wherein the third position and third orientation in the virtual space correspond to a position and orientation in the virtual space at which the pointer was located at a predetermined point in time before the pointer was located in the second position and second orientation in the virtual space.

3. The system of claim 2, wherein the third position and third orientation in the virtual space are substantially the first position and first orientation in the virtual space.

4. The system of claim 3, wherein the tracking device is configured to determine the predetermined point in time based upon measurements taken of the position and orientation of the freehand user input device or the pointer over a first period of time.

5. The system of claim 4, wherein the tracking device is configured to measure an offset of the freehand user input device or pointer, wherein the offset is a second period of time.

6. The system of claim 5, wherein the second period of time measured by the tracking device is the time from beginning of a button press to the activation of the button.

7. The system of claim 5, wherein the second period of time measured by the tracking device includes measurements of the position and orientation of the freehand user input device or pointer at points in time prior to the detection of the button press.

8. The system of claim 7, wherein the tracking device is configured to measure the X-axis, Y-axis and Z-axis positions in measuring the offset.

9. The system of claim 8, wherein the tracking device is configured to measure the yaw, pitch and roll orientations in measuring the offset.

10. The system of claim 1, wherein the tracking device is configured to detect a position of an object.

11. The system of claim 1, wherein the tracking device is configured to correlate the button activation to the third position and third orientation by associating the effect of the button activation to the third position and third orientation.

12. The system of claim 1, wherein the tracking device is configured to correlate the button activation to the third position and third orientation by moving the pointer to the third position and third orientation.

13. The system of claim 12, wherein the tracking device is configured to affect a virtual object that is spatially related to the third position and third orientation based on the button activation.

14. The system of claim 1, wherein the pointer is a virtual beam rendered in the virtual space.

15. A system, comprising:
a display screen configured to render a projected virtual space to a user comprising one or more projections;
a freehand user input device having a button;
a tracking device configured to:
position a virtual pointer in a first position and a first orientation in the virtual space correlated to a first position and first orientation of the freehand user input device in the physical space, where the first position and the first orientation in the virtual space intersects a virtual object at the first position and first orientation in the virtual space;
detect that the button has been activated on the freehand user input device to affect the virtual object at the first position and the first orientation in the virtual space;
detect that the freehand user input device has moved to a second position and second orientation in the physical space and the virtual pointer has moved to a second position and second orientation in the virtual space;
correlate the activation of the button to the first position and first orientation in the virtual space in response to the detecting;
upon detecting that the button has been activated on the freehand user input device, perform the button activation effect on the virtual object; and
render the object in rendering the projected virtual space on the display screen.

16. A system, comprising:
a display screen configured to render a projection of a virtual space to a user comprising one or more projections;
a freehand user input device having a button; and
a tracking device configured to:
position a virtual pointer in a first position and a first orientation in the virtual space with a one to one correspondence to a first position and first orientation of the freehand user input device in the physical space;
detect that a button has been pressed on the freehand user input device to affect the one or more projections in the virtual space;
detect that the freehand user input device has moved to a second position and second orientation in the physical space and the virtual pointer has moved to a second position and second orientation in the virtual space;
move the pointer in the virtual space to a third position and third orientation in the virtual space in response to the detecting, independent of the second position and second orientation of the freehand user input device in the physical space; and
upon performing the effect, return the position and orientation of the virtual pointer in the virtual space to a one to one correspondence with the position and orientation of the freehand user input device in the physical space.

17. A method, comprising:
positioning and/or orienting a freehand user input device in a first position and first orientation in a physical space, wherein the positioning and/or orienting causes a corresponding virtual pointer in a virtual space to be positioned and/or oriented in a first position and a first orientation in the virtual space;
detecting that a button has been activated on the freehand user input device to affect a virtual object in the virtual space associated with the corresponding virtual pointer's first position and first orientation, wherein the freehand user input device has moved to a second position and second orientation in the physical space and the corresponding virtual pointer has moved to a second position and second orientation in the virtual space; and
correlating the activation of the button to a third position and third orientation in the virtual space in response to the detecting.

18. The method of claim 17, wherein the third position and third orientation in the virtual space is a position and orientation at which the pointer was located at a predetermined point in time before the pointer was located in the second position and second orientation in the virtual space.

19. The method of claim 18, wherein the button activation affects a virtual object that is spatially related to the third position and third orientation.

20. The method of claim 18, wherein the third position and third orientation in the virtual space is substantially the same position and orientation as the first position and first orientation in the virtual space.

21. The method of claim 20, wherein the predetermined point in time is a constant which is calculated based upon measurements taken of the position and orientation of the freehand user input device or the pointer over a period of time.

22. The method of claim 21, further comprising measuring an offset of the freehand user input device or the pointer, wherein the offset is a period of time.

23. The method of claim 22, wherein the measurements taken are a measurement of position and orientation of the freehand user input device or the pointer over time from beginning to completion of a button activation.

24. The method of claim 23, wherein the measurements taken include one or more of X-axis position, Y-axis position, Z-axis position, yaw orientation, pitch orientation and roll orientation value.

25. The method of claim 17, wherein the button activation causes the movement of the freehand user input device to the second position and second orientation.

26. The method of claim 17, wherein the first position and a first orientation in the virtual space corresponds to a point.

27. The method of claim 17, wherein the first position and a first orientation in the virtual space corresponds to a region.

28. The method of claim 17, further comprising measuring an offset of the freehand user input device or pointer, wherein the offset is a period of time.
